(19) United States
(12) Patent Application Publication
(10) Pub. No.: US 2007/0122774 A1
(43) Pub. Date: May 31, 2007

(54) Easy sense language learning self-aid system

(76) Inventor: Weiqian Wang, Hui Zhou (CN)

Correspondence Address: Raymond Y. Chan, 108 N. Ynez Ave., #128, Monterey Park, CA, 91754, US

(21) Appl. No.: 11/282,397

(22) Filed: Nov. 18, 2005

(30) Foreign Application Priority Data
Nov. 11, 2005 (CN) 200510115791.3

(51) Int. Cl. G09B 5/00

(52) U.S. Cl. 434/169

(57) ABSTRACT

The present invention discloses a language learning self aid system utilizing a character centered cognitive scenario as a language learning carrier for assisting the language learner to speak, think, write, read and understand the target language with an efficient manner, wherein the language teaching method includes a principle ‘I think, I do, I practice’ is associated with the self aid system to generate a plurality of cognition scenrios and related practice sentences, so that by subsequently practicing such practice sentences, the students are able to grasp the essence of the language within a short period.

### BACKGROUND OF THE PRESENT INVENTION

1. Field of Invention

The present invention relates to a language learning tool as well as coding program, and more particularly, relates to an easy sense language learning self-aid system kit utilizing a plurality of character centered cognitive scenarios as a language learning carrier for assisting the language learner to speak, think, write, read and understand the target language with an efficient manner.

2. Description of Related Arts

Language acquisition is one of the crucial topics in cognitive science, especially for learning a foreign language. Language is the main vehicle by which people could understand other people's thought and intentions. In most cases, the foreign language must be directly or indirectly interpreted into the learner's mother tongue language. That is to say, every time a beginner wants to practice the foreign language, he or she would involuntarily convert the foreign language into his own language with a familiar format, mostly a first person expression or in a first person scenario, so that the facts of the language structure could be easily grasped.

Commonly, young children all have an innate language learning ability. Learning a first language is something every child does successfully in a matter of a few years and without a need for formal lessons. At the very first stage, the easiest language is so close to the core of what it means to the people himself. Afterwards, people automatically integrate the rules for grammar and learn to pronounce the sounds with their own language.

However, as people grow older, they would more or less lose this natural ability to learn a language. Each language has its own grammar rules, vocabulary and pronunciation variances. Therefore, learning another language is much more than learning the vocabulary of that language. Instead, a language learner must plug the new vocabularies into his own way to express means or describe things. In other words, learning foreign languages just like airdrop the learner into an exotic environment, language acquisition is not inherently interesting to him. He or she has to find a familiar scenario to feel easiness and intrepidness.

That is to say, a foreigner will prefer to learn language using his first person principles of the cognitive systems as his perception and reasoning tools. It is understood that people understand the world from their own first-person cognition. Therefore, a best approach for foreign language learner would be learning to think in the foreign language, speak and practice the foreign language with the first-person expression.

Unfortunately, conventional language learning books, dictionaries, self-aid cards as well as related learning stuffs unexceptionally employ grammar, memorization, and repetition as learning means to teach students handle the foreign language. This mechanically memorizing method had been proven to be a dead end to most people. Students would always complain about the hassles for reciting the alphabetically sorted vocabulary. It is desirable to develop a language learning self-aid dictionary kit, which utilizes first person expression means thus ensuring the student learn foreign languages with a much practical, effective and fast manner.

### SUMMARY OF THE PRESENT INVENTION

A primary object of the present invention is to provide a language learning self-aid system utilizing a plurality of first-person cognitive expressions and scenarios as a learning vehicle so as to assist the language learner think, understand, speak, read, and write the language in an effective way.

Another object of the present invention is to provide a language learning self-aid system employing the character centered cognitive logic to facilitate the language learner review the language learning process.

Another object of the present invention is to provide a language learning self-aid system having a variety of practicing stuff, such as books, CDs, Games, Websites, and pictures etc.

Another object of the present invention is to provide a language learning self-aid system, wherein the person pronoun of the cognitive expression could be alternatively converted for exploring the language learning scenario.

Another object of the present invention is to provide a language learning self-aid system, wherein a user is able to utilize such simple system or practicing tool to promptly learn foreign language within a short period.

Another object of the present invention is to provide a language learning self-aid system, which could provide the student an accessible learning tool so as to assist the student practice the language in surrounding environments.

Another object of the present invention is to provide a language learning self-aid system, wherein no enormous vocabulary memorization, repetition, and redundant grammar practices would be required for the learners to handle the language.

Another object of the present invention is to provide a foreign language learning method, which employ the above mentioned language learning self-aid system for facilitating the language learners to establish a ‘I think, I do, I practice’ mode so as to facilitate the language learners to establish a self-centered language learning atmosphere.

Accordingly, to achieve above mentioned objects, the present invention provides a language learning self-aid system, comprising:

a plurality of practice sentences compiled in an assorted manner, wherein each of said practice sentences employs a character as a subject; and

a plurality of vocabularies of said language alphabetically and sequentially embedded into said respective practice sentences, such that a language learner is able to subsequently practice the practice sentences to establish a self-centered cognitive scenarios for promptly learning the language These and other objectives, features, and advantages of the present invention will become apparent from the following detailed description, the accompanying drawings, and the appended claims.

### BRIEF DESCRIPTION OF THE DRAWINGS

FIG. 1 is a schematic view illustrating a language learning method utilizing the self-aid system according to a preferred embodiment of the present invention.

### DETAILED DESCRIPTION OF THE PREFERRED EMBODIMENT

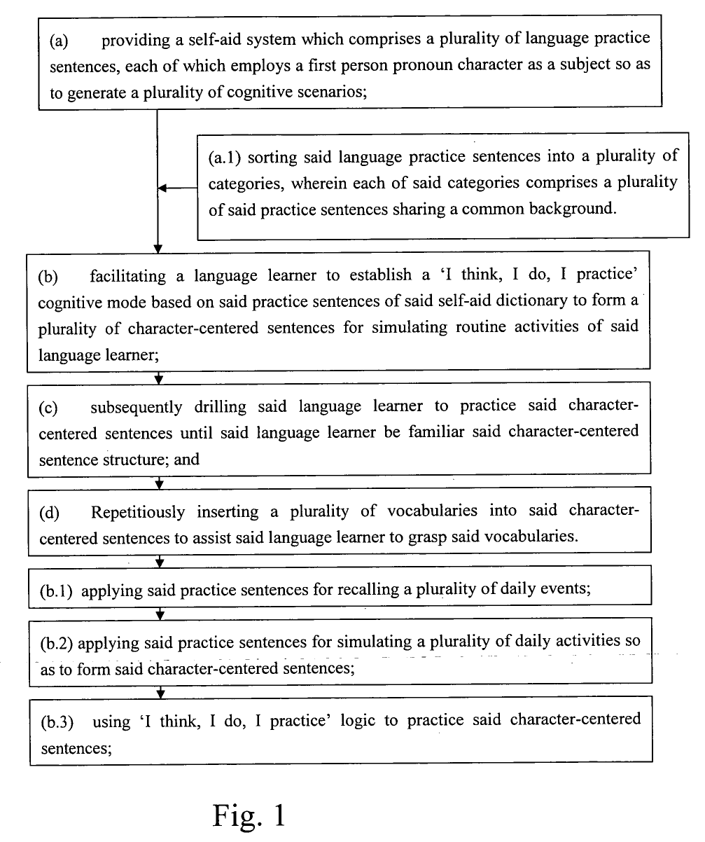

Referring to FIG. 1, a language learning method according to the present invention is illustrated. The core part of the learning method is to provide a language learning self-aid system, which comprises a plurality of practice sentences compiled in an assorted manner, wherein each of the practice sentences employs a first-person character as a subject. Moreover, the self-aid system further comprises a plurality of vocabularies of the language alphabetically and sequentially embedded into the respective practice sentences. As a result, a language learner is able to subsequently practice the practice sentences to establish a plurality of self-centered cognitive scenarios for promptly learning the language.

In other words, the self-aid system of the present invention provides a user a plurality of self-practice sentences, wherein each of the sentences unexceptionally employs a first-person pronoun, such as I, and We. This is due to the fact that such first-person pronouns would definitely lead the user into self-centered scenarios while learning a foreign language. On the other hand, the self-aid system further provides a plurality of supplemental sentences wherein the first-person characters are replaced with other pronouns or characters, such as he, she, they, it, and so on.

That is to say, the self aid system of the present invention provides language practitioners or language learners an effective tool to practice the language with a user-friendly and self-centered manner. The language practitioners could voluntarily imagine himself or herself spotted into a variety of scenarios so as to ultimately obviate the fears in learning foreign language.

What is more, the self-aid system of the present invention provides a plurality of language practice sentences spanning across a wide range of topics in routine life, wherein the language practitioner could selectively choose pertinent topics depending on his or her special requirements. Compared with the conventional dictionary mechanically and alphabetically sorting the vocabularies, the self-aid system of the present invention provides a plurality of scenario backgrounds instead. Such scenario backgrounds are indexed so that a user is able to check the practice sentences and words easily.

Since each of the practice sentences unexceptionally includes a character, preferably a first person human character, as the subject of the sentence, a user is able to associate himself or herself into different situations while looking up the self-aid system. As a result, the system of the present invention could be conveniently converted into different forms, such as text book, self-aid CD, Games, language learning website as well as any learning means employing such ideas.

It is noted that the language learner is able to replace the character with any person pronoun or human character to exercise the language from different angles. That is to say, the subject of the practice sentences could be defined as a first person pronoun, such as I and we, a second person pronoun, such as you, and a third person pronoun, such as he, she, they, or any human character's name or animal character's name, such as Tom, Mary, and Mickey Mouse. Finally, he or she would subsequent practice the plurality of practice sentences to strengthen his or her language cognition and understanding.

Through such replacements and practices, the language learner will appreciate the practice sentences in his or her own thinking logic. According to the present invention, a language learner will plug the new vocabularies appeared in the practice sentences into his own imagination or cognitive way to express feelings and describe things. This is due to the fact all subjects of the practice sentences are exclusively preoccupied with human characters. The language learners would automatically and subconsciously associate the human character of the practice sentences to him or to his love ones. As mentioned before, learning a foreign language is analog to airdropping a learner into an exotic and strange environment. However, according to the preferred embodiment, the language learner will promptly associate himself to a familiar scenario thus fading such maladjusted fear effectively. Gradually, the language learner will subsequently practice a plurality of practice sentences. As a result, he or she will associate himself into a variety of scenarios under a new language circumstance, and ultimately make himself feel easiness and intrepidness whenever talking to native language speakers.

Moreover, the practice sentences as well as the vocabularies of the self-aid system could be compiled with different difficult grade. For example, for the primary grade students as well as intermediate students, the words of each practice sentence should be limited no more than 12 words. On the other hand, the vocabularies to be plugged into the practice sentences are gradually tougher based on student's learning process. That is to say, the practice sentences and the vocabularies are not only sorted based on different scenarios, but also purposely compiled to feed into language practitioners of different level.

Accordingly, the present invention also provides a language teaching method based on the above mentioned self-aid system, wherein such teaching method is adapted to be used in conjunction with the self-aid system to expedite the ability to communicate in a foreign language, the teaching method comprises the following steps:

(a) providing a self-aid system which comprises a plurality of language practice sentences, each of which employs a first person pronoun character as a subject so as to generate a plurality of cognitive scenarios;

(b) teaching a language learner to establish a ‘I think, I do, I practice’ cognitive mode based on the practice sentences of the self-aid system so as to form a plurality of character-centered sentences for simulating routine activities of the language learner;

(c) subsequently trilling the language learner to practice said character-centered sentences; and

(d) Repetitiously inserting a plurality of vocabularies into the character-centered sentences to facilitate the language learner to grasp the vocabularies.

In step (a), the language learner is provided with a self-aid system of the present invention. The system of the present invention is different with conventional dictionaries, wherein the vocabularies are compiled into a plurality of practice sentences.

Moreover, the step (a) method of the present invention further comprises a step (a.1) for sorting the plurality of language sentences into different categories, wherein each category is adapted to collect language sentences with similar background. That is to say, the plurality of the language practice sentences are sorted into different categories, such as waiting room category, transport category, driving category, working category, activities category, restaurant category, concert category, and so on. Therefore, each category comprises a plurality of similar practice sentences relating to a same topic.

Accordingly, a language learner is able to practice such sentences selected into one of the categories to practice. In other words, the assorted categories for practicing the language are compiled into the self-aid system. The self-aid system comprises at least a plurality of classified categories, such as transporting sentences, routing activities sentences, social activities sentences, etc. Such classified categories are prepared with an indexed list, so that the language learner is able to look up the self-aid book regarding to his requirement.

Preferably, each category comprises no more than twelve practice sentences, wherein each of the practice sentences contains no more than twelve words. In such an arrangement, the practice sentence is susceptible to be memorized by the students in convenience. For instance, the transporting category includes the following sentences, I cross at the crosswalk; I go into the train station; I stand in line to buy a ticket; I get my ticket; I take out my ticket; I show my ticket at the ticket wicket; I have my ticket punched; I go through the ticket wicket; I wait on the platform; I stop at a newsstand; I buy a newspaper; I sit on the bench as shown in FIG. 2. It is seen that twelve short and simple sentences sharing a common background are collected with the category for a convenient practice. Using such relatively simple sentence structure, the language learner is able to grasp the essence of the foreign language. And accordingly, after practicing several such categories, the user is able to build up his foreign language thinking power to cover a variety of scenarios.

Conventionally, a foreigner will prefer to learn language using his first person principles for achieving a better perception and reasoning analysis. That is to say, converting the foreign language sentences into first person expression is an easy way to most language learners. Accordingly, the step (b) of the preferred embodiment of the present invention further comprises following steps, (b.1) applying the practice sentences for recalling a plurality of daily events occurred to a user;

(b.2) applying the practice sentences for simulating the daily activities for forming character-centered sentences; and

(b.3) using ‘I think, I do, I practice’ logic to practice the character-centered sentences; and

To establish a friendly learning environment, the language teaching method of the present invention introduces a principle ‘I think, I do, I practice’ in the language cognition world. It is understood that people understand the world from their own first-person cognition. Therefore, a best approach for a foreign language learner would be thinking the foreign language, speaking and practicing the foreign language with a first-person expression. In the step (b.1), a language learner would recall all daily events with a collective manner. It is noted this step is adapted to assist the language learner thinking in the foreign language with the first person cognition. Afterwards, the language learner would simulate the daily activities with the first person cognition thus generating the character-centered sentences. The character-centered sentences would be focused on the learner himself so as to generate a plurality of self-centered sentences. Such practices would significantly assist the language learner to speak and use the foreign language within intrepid manner. After constant practices, the user would command the routing applications in foreign languages. As a result, when he or she encountered a native foreign language speaker, he or she would recall the familiar sentences from his daily practicing memory so as to cope with the conversation. Finally, in the step (d), the language learner is able to embed any new vocabularies into the established character centered sentences to enrich his foreign language thinking power.

It is worth to mention that the principle ‘I think, I do, I practice’ could be replaced with ‘we think, we do, we practice’ or ‘they think, they do, they practice’ in applications.

What is more, in case the first person pronoun such as I, we could be applied as a subject in the practice sentence, the first person pronoun could be correspondingly replaced as related first person pronoun such as my, me, our, us etc.

Conclusively, the foreign language teaching method of the present invention is set up to allow the student to learn how to speak, think, write, read and understand the target language with a character centered cognition principle. Equipped with a self-aid book provided by the present invention, the student is able to grasp the essences of the foreign language in a variety of scenarios. This is due to the fact the method primarily provides a plurality of relatively simple practice sentences well assorted into different categories, the student just merely follow the ‘I think, I do, I practice’ principle to follow the practice sentences to build up his foreign language learning power.

Finally, it is worth to mention that the learning method of the present invention could be used to teach lower level students in schools. Since each category includes only twelve sentences, the foreign language teaching lesson could be defined as a half-hour class, during which a teacher could instruct the student to think, to do and to practice the practice sentences listed on the category.

In the following examples, some contents of the self-aid system are retrieved for further illustrating the characteristics of the present invention. As mentioned before, the practice sentences could be sorted into different categories, such as bedroom category and working category as shown in Example one.

### EXAMPLE ONE

### Bedroom Category for Elemental School Students

1. I hear the alarm
2. I look at the clock
3. I turn off the alarm
4. I throw back the covers
5. I get up
6. I get out of bed
7. I put on my school uniform
8. I turn on the TV
9. I open the curtains
10. I look out the window
11. I make the bed
12. I fold up my bedding

Or otherwise, the first person character could be replaced with other pronoun or characters for practices.
Tom hears the alarm.
Tom looks at the clock.
Tom turns off the alarm.
Tom throws back the covers.
Tom gets up.
Tom gets out of bed.
Tom puts on my school uniform.
Tom turns on the TV.
Tom opens the curtains.
Tom looks out the window.
Tom makes the bed.
Tom folds up my bedding.
You hear the alarm.
You look at the clock.
You turn off the alarm.
You throw back the covers.
You get up.
You get out of bed.
You put on my school uniform.
You turn on the TV.
You open the curtains.
You look out the window.
You make the bed.
You fold up my bedding.

It is seen that each practice sentence comprises no more than 12 relative simple words and all sentences are correlated with a common topic.

Or otherwise, the vocabularies could be alphabetically inserted into the predetermined practice sentence to help language practitioner to learn new words.

### EXAMPLE TWO

### Self-aid System with Vocabularies Inserted into Different Practice Sentences.

I have a beautiful bag.
I want to buy an apple.
I am an able child.
I give him about ten books.
I find an egg above the ice.
I saw the accident yesterday.
I am not afraid of her.
I have never seen him after then.
I met him in the afternoon.
I can speak it to you a gain.
I visit the farm ten days ago.
I go there by air.
I stay at home all day.
I almost fell down.
I walk along the river.
I have already finished my homework.
I also can sing that song.
I am always early for school.
I visit America.
I have an American friend.
I bought pineapples and pears.
I am angry with you.
I know a lot of animals.
I want to eat another mooncake.
I answer the telephone.
I can be here any day.
I can do anything for you.
I give my brother a big apple.
I cheated him on April 1 st.
I walk with my mother arm in arm.
I can show you around our company.
I arrive at the village in time.
I have art lesson.
I will tell him as soon as he comes.
I ask my teacher many questions.
I am still at school.
I go to Japan in August.
I dance with my aunt.
I have never been to Australia.
I was born in autumn.
I keep the dog away from me.
I have been here 5 years.
I pick up the yellow leaves.
I say yes to him.
I had a picnic yesterday.
I am yet a child.
I take you as my best friend.
I am a Yong Pioneer.
I borrow your rubber.
I think the car is yours.
I think you should buy yourself a skirt.
I think you will hurt yourselves like that.
I don't believe I got zero mark.
I saw a lot of animals in the zoo.
Tom doesn't believe he got zero mark.
Tom saw a lot of animals in the zoo.

It is seen that vocabularies inserted into the practice sentences are highlighted and alphabetically and subsequently plugged into each practice sentence, such that a user is able to practice the practices and vocabularies in a user friendly manner.

### EXAMPLE 3

### The Same Character Could be Applied in Different Practice Sentences.

The Elementary School Behavior Manual Is Showing Below
1. I remember other people's birthday.
2. I compliment two people every day.
3. I often say “thank you”.
4. I often say “please”.
5. I'm the first to say “hello”.
6. I return all things I borrow.
7. I treat everyone the way like I want to be treated.
8. I keep secrets.
9. I show respect for teachers.
10. I stop blaming others.
11. I take out the garbage without being told.
12. I take responsibility for every areas of my life.
13. I take part in a charity in my community.
14. I support a charity.
15. I give to charity all the clothes I haven't worn.
16. I remember the most important thing in family relationship is trust.
17. I don't smoke.
18. I don't associate with those who mess with drugs.
19. I use credit cards only for convenience, never for credit.
20. I never cheat.
21. I never use profanity.
22. I remember people's names.
23. I pay my bills on time.
24. I use seat belts.
25. I keep neat.
26. I'm punctual.
27. I avoid negative people.
28. I read carefully anything that requires my signature.
29. I never take action when I'm angry.
30. I measure people by the size of their hearts.
31. I measure people not by the size of their bank accounts.
32. I'm the most positive and enthusiastic person you know.
33. I return borrowed vehicles with the gas tank full.
34. I observe the speed limit.
35. I don't waste time grieving over past mistakes.
36. I'm a good loser.
37. I'm a good winner.
38. I keep a daily journal.
39. I keep my promises.
40. I drink eight glasses of water every day.
41. I respect tradition.
42. I show respect for other's time.
43. I call whenever I'm going to be more than ten minutes late for an appointment.
44. I take good care of those I love.
45. I'm modest.
46. I don't gossip.
47. I don't discuss salaries.
48. I don't gamble.
49. I never go to bed with dirty clothes.
50. I contribute five percent of my income to charity.
51. I make the bed when I'm an overnight guest in someone's home.
52. I don't waste time playing cards.
53. I refrain from envy.
54. I'm courteous to everyone.
55. I compliment even small improvements.
56. I focus on making things better.
57. I don't be afraid to say“I'm sorry”.
58. I look for opportunities to make people feel important.
59. I'm open to new ideas.
60. I set short-term and long-term goals.
61. I don't interrupt.
62. I'm prepared.
63. I give thanks before every meal.
64. I don't make the same mistake twice.
65. I love my country.
66. I love my people.
67. I have confidence in myself.
68. I can plant a dream.
69. I cherish all my happy moments.
70. I depend not on fortune but on conduct.
71. I must be resolutely determined.
72. I can always pitch better.
73. I love my life.
74. I never give up.
75. I control my emotions.
76. I change my attitude is to change my life.
77. I cultivate good habits.
78. I'm special.
79. I accept the challenges.
80. I keep my heart free from hate.
81. I keep my mind from worry.
82. I expect little and give much.
83. I enjoy what I've got.
84. I believe in myself.
85. I don't complain because I don't have.
86. I choose a goal and stick to it.
87. I'm sure to win.
88. I'm the best.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A language learning self-aid system, comprising:
a plurality of practice sentences compiled in an assorted manner, wherein each of said practice sentences employs a character as a subject; and
a plurality of vocabularies of said language alphabetically and sequentially embedded into said respective practice sentences, such that a language learner is able to subsequently practice the practice sentences to establish a plurality of character-centered cognitive scenarios for promptly learning the language

2. The language learning self-aid system, as recited in claim 1, wherein said practice sentences are classified into a plurality of categories each of which having a plurality of said practice sentences sharing a common topic.

3. The language learning self-aid system, as recited in claim 1, wherein said character is a first-person pronoun for facilitating said language learner to establish a self-centered cognitive scenarios.

4. The language learning self-aid system, as recited in claim 2, wherein said character is a first-person pronoun for facilitating said language learner to establish a self-centered cognitive scenarios.

5. The language learning self-aid system, as recited in claim 1, wherein said vocabularies are categorized into a plurality of toughness grade.

6. The language learning self-aid system, as recited in claim 2, wherein said vocabularies are categorized into a plurality of toughness grade.

7. The language learning self-aid system, as recited in claim 1, further comprising means for packaging said self aid system, wherein said packaging means is selected from a group consisting of text book, CD, Website, Video&Audio cassette, Game, and so on.

8. The language learning self-aid system, as recited in claim 4, further comprising means for packaging said self aid system, wherein said packaging means is selected from a group consisting of text book, CD, Website, Video&Audio cassette, Game, and so on.

9. The language learning self-aid system, as recited in claim 6, further comprising means for packaging said self aid system, wherein said packaging means is selected from a group consisting of text book, CD, Website, Video&Audio cassette, Game, and so on.

10. A foreign language teaching method, comprising the following steps:
(a) providing a self-aid system which comprises a plurality of language practice sentences, each of which employs a first person pronoun character as a subject so as to generate a plurality of cognitive scenarios;
(b) facilitating a language learner to establish a ‘I think, I do, I practice’ cognitive mode based on said practice sentences of said self-aid system to form a plurality of character-centered sentences for simulating routine activities of said language learner;
(c) subsequently trilling said language learner to practice said character-centered sentences until said language learner be familiar said character-centered sentence structure; and
(d) Repetitiously inserting a plurality of vocabularies into said character-centered sentences to assist said language learner to grasp said vocabularies.

11. The method, as recited in claim 10, wherein the step (a) further comprises a step (a.1) for sorting said language practice sentences into a plurality of categories, wherein each of said categories comprises a plurality of said practice sentences sharing a common background.

12. The method, as recited in claim 1, wherein the step (b) of the present invention further comprises following steps:
(b.1) applying said practice sentences for recalling a plurality of daily events;
(b.2) applying said practice sentences for simulating a plurality of daily activities so as to form said character-centered sentences; and
(b.3) using ‘I think, I do, I practice’logic to practice said character-centered sentences;

13. The method, as recited in claim 11, wherein the step (b) of the present invention further comprises following steps:
(b.1) applying said practice sentences for recalling a plurality of daily events;
(b.2) applying said practice sentences for simulating a plurality of daily activities so as to form character-centered sentences; and
(b.3) plugging a plurality of vocabularies into said character-centered sentences.

14. The method, as recited in claim 11, wherein each of said categories comprises at most twelve said practice sentences, wherein each of said practice sentences comprise at most twelve words.

15. The method, as recited in claim 12, wherein each of said categories comprises at most twelve said practice sentences, wherein each of said practice sentences comprise at most twelve words.

16. The method, as recited in claim 10, wherein said vocabularies are alphabetically plugged into said practice sentences.

17. The method, as recited in claim 11, wherein said vocabularies are alphabetically plugged into said practice sentences.

18. The method, as recited in claim 12, wherein said vocabularies are alphabetically plugged into said practice sentences.

19. The method, as recited in claim 14, wherein said vocabularies are alphabetically plugged into said practice sentences.

20. The method, as recited in claim 15, wherein said vocabularies are alphabetically plugged into said practice sentences.
